(19) United States
(12) Patent Application Publication
(10) Pub. No.: US 2019/0277316 A1
(43) Pub. Date: Sep. 12, 2019

(54) Device for Controlling the Flow Direction of Fluids

(71) Applicant: SIG Technology AG, Neuhausen am Rheinfall (CH)

(72) Inventors: Johannes Hortmanns, Wegberg (DE); Christian Rabe, Aachen (DE)

(21) Appl. No.: 16/336,571

(22) PCT Filed: Sep. 6, 2017
(86) PCT No.: PCT/EP2017/072342

§ 371 Date: Mar. 26, 2019

(30) Foreign Application Priority Data
Sep. 30, 2016 (DE) 10 2016 118 579.5

(51) Int. Cl. F15D 1/04; F16L 41/02

(52) U.S. Cl. CPC F15D 1/04; F16L 2201/40; F16L 41/021

(57) ABSTRACT

A device for controlling the flow direction of fluids, in particular flowable foods, includes a housing with at least three connections, wherein the connections are inlets and/or outlets for the fluids, wherein the first connection is arranged on a first axis, wherein the second connection is arranged on a second axis, and wherein the third connection is arranged on a third axis which runs at an angle to the first axis and the second axis. In order that the flow direction of the fluid inflowing into the device is changed, while avoiding certain disadvantages, a guide element is provided for dividing the flow inflowing into the housing into at least two partial flows. Also shown and described are the use of such a device for filling food and a system for filling food with such a device.

The invention relates to a device for controlling the flow direction of fluids, in particular flowable food, comprising: a housing having at least three connections, wherein the connections are inlets and/or outlets for the fluids, wherein the first connection is arranged on a first axis, wherein the second connection is arranged on a second axis, and wherein the third connection is arranged on a third axis which is at an angle to the first axis and the second axis.

The invention also relates to the use of such a device in the filling of foods.

Finally, the invention relates to a system for filling foods with such a device.

Flowing fluids, such as gases or liquids, can be influenced in different ways. The aim of this influencing can be, for example, a control or regulation of the flow rate or the flow direction of the fluids. The flow direction of fluids can be influenced, for example, by multi-way valves, which are characterised in that they have three or more fluid connections and are switchable. In this way, for example, two inlets can be alternately connected to the same outlet and thus the flow can be directed in different directions. In addition, both inlets can be closed, so that the flow is completely interrupted.

Particularly high standards of hygiene are demanded in the control of fluids for the filling of food. The food may be, for example, liquid foods such as milk or juice. Likewise, it may be liquid foods with lumpy ingredients, such as soup, rice pudding, juices with pieces of fruit or the like. A requirement of hygiene is that the pipes and valves must be easy to clean. This requirement arises from the fact that several different foods are regularly filled one after the other using the same system. In the case of a product change, therefore, the system must be cleaned very thoroughly. To ensure this, the pipes and valves should be designed in such a way that as far as possible no food is deposited and allowed to settle there. Many designs, such as valves with moving internal parts, are therefore usually unsuitable for filling food.

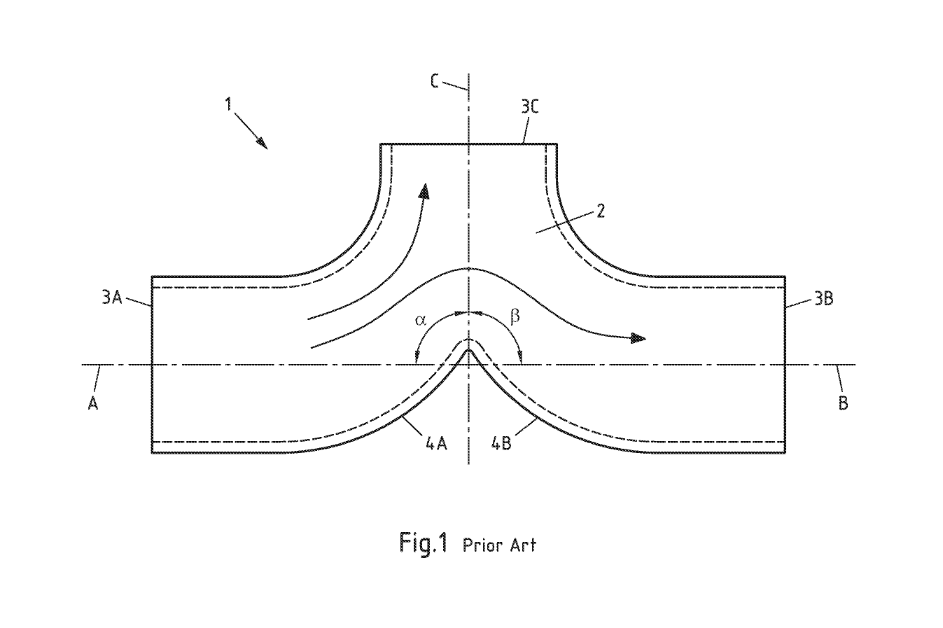

For example, the device shown in FIG. 1 for controlling the flow direction of fluids is known from the prior art. The device comprises a housing of two opposite connections and has a third connection arranged between these two connections.

The third connection is angled at approximately 90° to the other two connections, which is why such a device is also referred to as a “T-piece”. The device shown in FIG. 1 is used, for example, to guide food to be filled from a container into a plurality of product tanks and from there to fill packaging. The container is for this purpose connected to the inlet (left in FIG. 1) and the product tanks are connected to the outlets (top and right in FIG. 1).

The device shown in FIG. 1 can be used as an “intermediate piece” or as an “end piece”. When used as an intermediate piece, all three connections are open, wherein one connection serves as an inlet and two connections serve as outlets. When used as an end piece, however, one connection is closed so that one of the remaining connections serves as an inlet and the other remaining connection serves as an outlet.

The use as an intermediate piece serves to supply several product tanks and thus also several filling sections at the same time. To accomplish this, a container of food to be filled is connected to the inlet of the device while the first outlet leads to a product tank and the second outlet leads to the inlet of another device. There is again a division into a product tank and another device. Since the product tanks are filled from below for various reasons (e.g. avoidance of foaming, self-draining), the outlet connected to the product tank must be directed vertically upwards. To redirect the flow accordingly, the housing is shaped such that some inner walls are curved. However, this design has the disadvantage that the device no longer ensures a continuous straight connection in its lower region between the two opposite connections. This makes the use of the device in self-draining systems impossible because, for example, detergent cannot drain off since the curved inner walls are an obstacle in the way.

On the other hand, the use as an end piece serves to guide the food into the last product tank. Again, the flow must be directed vertically upwards. The third connection has, at least during filling, no function and is closed; this connection can be opened, for example, during cleaning of the system or for other purposes. The closing of one of the connections of the device, however, has the disadvantage that the food conducted through the device almost comes to a standstill in the area in front of the closed connection. The area in front of the closed connection is therefore not sufficiently flushed out. This has the disadvantage, in particular in the case of lumpy food items (e.g. rice, peas, fruit pieces, etc.), that the lumpy components could deposit in front of the closed connection and block this connection. The deposits or blockages obstruct those steps (e.g., cleaning) where this connection must be reopened.

Against this background, the present invention seeks to design and redevelop the device mentioned above and previously described in such a way that the flow direction of the fluid inflowing into the device is changed without the aforementioned disadvantages occurring.

This object is achieved with a device according to the preamble of Claim 1 by a guide element for dividing the flow inflowing into the housing into at least two partial flows.

The device according to the invention serves to control the flow direction of fluids, in particular flowable food. The term ‘fluids’ is understood to mean both gaseous and liquid media. Flowable foods are foods which either have exclusively flowable, in particular liquid, constituents or also have flowable, in particular liquid constituents in addition to solid, lumpy constituents. The device is first characterised by a housing having at least three connections, which are inlets and/or outlets for the fluids. The connections are preferably circular, so that tubes with a circular cross section can be easily connected thereto. The housing is preferably hollow, so that it may be perfused by the fluids. In addition, the entire inner surface of the housing is preferably free of pores and thus particularly hygienic. The first connection is arranged on a first axis and the second connection is arranged on a second axis. The third connection is arranged on a third axis that runs at an angle to the first axis and the second axis. The straight axes run through the centres of the cross-sectional areas of the connections, therefore in the case of circular cross sections through the centres of the cross-sectional areas of the connections. The straight axes are also perpendicular to the cross-sectional areas of the connections. The fluids flowing through the housing must therefore change their flow direction when they flow from the first connection or from the second connection to the third connection or when they flow from the third connection to the first connection or to the second connection.

In order for this to be achieved according to the invention, it is proposed to provide a guide element for dividing the flow inflowing into the housing into at least two partial flows, firstly (through the first partial flow) to achieve a continuous delivery of the fluid to the outlet of the device, and secondly (through the second partial flow) to achieve a flushing of the housing in the area of the closed inlet (use as an end piece) or to facilitate a redirection to other parts of the system (use as an intermediate piece). The guide element is shaped such that it divides the fluid inflowing into the housing into two partial flows with different flow directions. In order to achieve different flow directions, either both partial flows are conducted by the guide element in different directions, or one of the partial flows is diverted by the guide element while the other partial flow can pass the guide element without thereby changing its flow direction. Preferably, the entire surface of the guide element is free of pores and thus particularly hygienic.

One configuration of the device provides that the housing and the guide element are designed in such a way that a first partial flow is conducted in the direction of a connection and that a second partial flow is conducted in the direction of another connection than the first partial flow. This design ensures that both partial flows are conducted to different connections. When used as an end piece, preferably one of the partial flows is conducted from the open inlet to the open outlet while the other partial flow is conducted from the open inlet to the closed inlet. This allows, on the one hand, a continuous flow of the device (from the open inlet to the open outlet) while purging the area in front of the closed inlet. Thus, the formation of deposits or blockages in the region of the closed inlet due to low flow is avoided. When used as an intermediate piece, it is also preferable to direct one of the partial flows from the open inlet to the first open outlet while directing the other partial flow from the open inlet to the other open outlet. This allows the redirection of a part of the flow to other devices (e.g. to achieve a series connection of product tanks).

According to a further configuration of the device, it is provided that the first axis and the second axis run mutually parallel, in particular mutually collinear. This embodiment provides that two connections of the device are arranged on parallel or in particular collinear axes. Preferably, the first axis and the second axis are continuous within the housing. The arrangement of two connections on collinear axes or on the same axis has the advantage that this partial flow flowing between these two connections does not need to change its flow direction. This facilitates use in a self-draining system. In addition, the collinear arrangement simplifies the manufacture by the use of pipe sections. An arrangement of two connections on parallel but not collinear axes, however, may be desired in the case of different diameters of the first connection and the second connection, in order to achieve an underside of the housing, which is straight when viewed in the direction of flow, despite the offset between the two axes.

In a further configuration of the device it is provided that the underside of the housing opposite the third connection is designed to be straight between the first connection and the second connection. Although the underside of the housing may be circumferentially curved, it should nevertheless be straight in the direction of a flow that flows from the first connection to the second connection. Due to the straight design of the underside, a free flow is achieved, which is important, for example, for use in self-draining systems. The underside of the housing should be straight at least in the region of the guide element; preferably, however, the bottom of the housing is designed to be continuously straight.

According to a further embodiment of the device it is provided that the third axis is inclined at an angle of at least 45°, in particular of at least 60°, relative to the first axis and/or relative to the second axis. By this embodiment it is achieved that the fluid undergoes a significant change in direction. This has the advantage that food can be conducted vertically from bottom to top in a product tank.

In a further configuration of the device it is provided that the angle between the third axis and the first axis and/or the second axis is in the range between 80° and 100°. This embodiment also ensures that the fluid undergoes a significant change in direction. In addition, an angle of approximately 90° has the advantage that the flow direction can be changed from a horizontal direction to a vertical direction.

According to a further embodiment of the device it is provided that the guide element is formed integrally with the housing. On the one hand, a one-piece design has the advantage of a reliable connection between the guide element and the housing and, moreover, is distinguished by a great degree of robustness, in contrast to separate components. Another advantage is that with the one-piece design a non-porous and therefore very hygienic connection can be achieved. It can be provided, for example, that the entire—preferably polished—inner surface of the housing has an average roughness Ra of 0.1 or finer, in particular of 0.05 or finer. The one-piece design can be achieved, for example, by a casting process or by a generative manufacturing process. For example, the device can be manufactured by laser melting, laser sintering or 3D printing.

In a further embodiment of the device it is provided that the guide element is designed as an insert, which is connected to the housing. In this embodiment, a plurality of separate components is initially provided, which are then joined together. One of these components is the (one-piece or multi-piece) housing, another of these components is the (one-piece or multi-piece) guide element. The assembly of several components has the advantage that complex geometries can be achieved even with cost-effective manufacturing processes. For example, the housing can be assembled from two half-shells welded together, which are produced, for example, by means of a forming process from a metal sheet. The multi-piece construction also has the advantage that the guide element can be retrofitted in existing housing or can be replaced. Preferably, the connection between the guide element and the housing is free of pores and thus particularly hygienic. It can be provided, for example, that all, preferably polished, surfaces that come into contact with the fluid (inner surface of the housing, surface of the guide element, connecting surfaces between housing and guide element) have an average roughness Ra of 0.1 or finer, in particular 0.05 or finer. It is preferable that all parts in a multi-piece construction (in particular the housing and the guide element) are made of the same material, which simplifies the welding.

With regard to the guide element, it is provided according to a further embodiment, that the guide element is connected with the housing via at least one bridge, in particular via two bridges. While the connection between the guide element and the housing is created by at least one narrow bridge, the flow resistance is increased as little as possible and the flow is influenced as little as possible. A single bridge may be provided; alternatively, two or more bridges may be provided. In a design with two bridges, for example, one of the two partial flows could be bounded laterally by the two bridges, that is to say run between the two bridges, while the other sub-stream runs alongside the two bridges or outside the two bridges.

With regard to the bridge, it is provided according to a further embodiment that the bridge has a length of at least 3 mm, in particular of at least 5 mm, so that a corresponding minimum distance between the guide element and the housing is maintained. By setting a minimum distance between the guide element and the inner wall of the housing, blockages are prevented, particularly in the case of lumpy food items (e.g., rice, peas, fruit pieces, etc.). The length of the bridge can be adjusted according to the size of these components.

Preferably, the length of the bridge is at most 0.25 times the inner diameter of the housing, in particular at most 0.15 times the inner diameter of the housing (for example in the region of the connections).

According to a further embodiment of the device, it is provided that the guide element divides the two partial flows in a ratio of at least 3:1, in particular of at least 4:1. This distribution ratio determines how large the flow volume of the first partial flow is in relation to the flow volume of the second partial flow. A ratio of 4:1 thus means that approximately 80% of the flow is supplied to the first partial flow while approximately 20% of the flow is supplied to the second partial flow. The size of the partial flows is determined by the size of the “channels” within the housing designated for the partial flows. Therefore, the ratio of the cross-sectional areas of the “channels” of the two partial flows should be at least 3:1, in particular at least 4:1.

According to a further embodiment of the device, it is finally provided that the housing and/or the guide element is/are made of stainless steel. Preferably, the housing and the guide element are made of the same material. The use of stainless steel in particular has hygienic advantages, since even with the use of cleaning agents corrosion should not be a concern. As a material, for example, a stainless steel with the material number 1.4404, 1.4435, 1.4157 or a higher-grade stainless steel can be used, wherein “superior” can be taken to mean, for example, a higher resistance to salt.

The device described above is particularly well suited for filling foods in all illustrated embodiments. This is due, in particular, to the ability to continuously flush the entire interior of the housing, including the area in front of a closed connection, and thus to prevent deposits. This is particularly due to the ability to be used in a self-draining system.

The object described above is also achieved by a system for filling foods, comprising: at least one device according to any one of Claims 1 to 11, at least one container for food to be filled, wherein the container can be connected to the first connection of the device, at least one product tank connected to the third connection of the device, at least one valve located between the third connection of the device and the product tank, and a plurality of outlets connected to the product tank for filling the food into packaging. By using the device described above, the advantages already discussed above are also achieved in the system: Firstly, a continuous conveyance of the fluid in the vertical direction to the product tank is achieved (by the first partial flow) and, secondly, a flushing of the housing in the area of the closed inlet or a redirection to a further device is achieved (by the second partial flow).

According to an embodiment of the system, it is finally provided that the third connection of the device is arranged above the first connection and the second connection. In other words, one of the connections should be arranged further above the floor in the vertical direction than the other two connections. Preferably, this connection is directed vertically upwards. This allows the connection of a product tank to be filled from below. This is achieved by a part of the flow in the device changing its flow direction.

The invention will subsequently be explained in more detail with reference to a drawing showing only a preferred embodiment. The drawing shows:

FIG. 1: a device known from the prior art for controlling the flow direction of fluids in a side view,

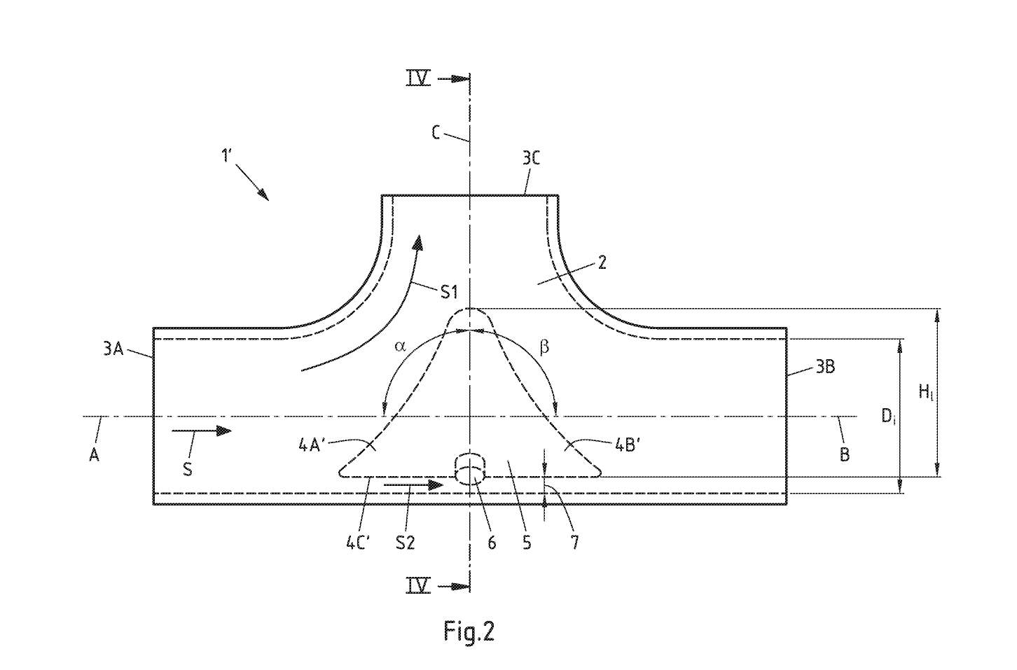

FIG. 2: a device according to the invention for controlling the flow direction of fluids in a side view,

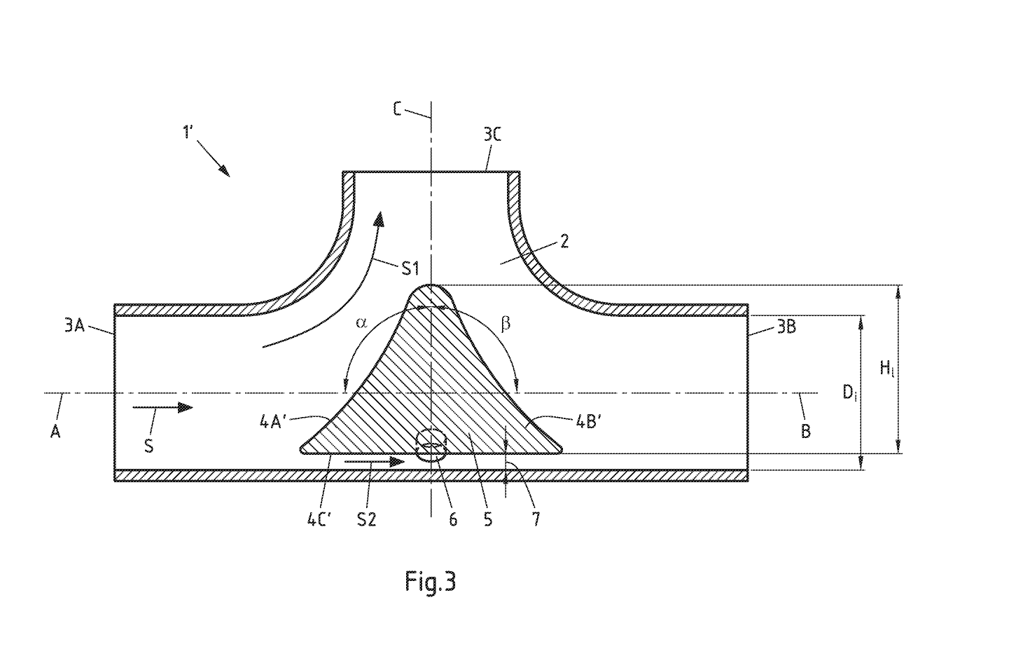

FIG. 3: the device from FIG. 2 in a longitudinal cross section,

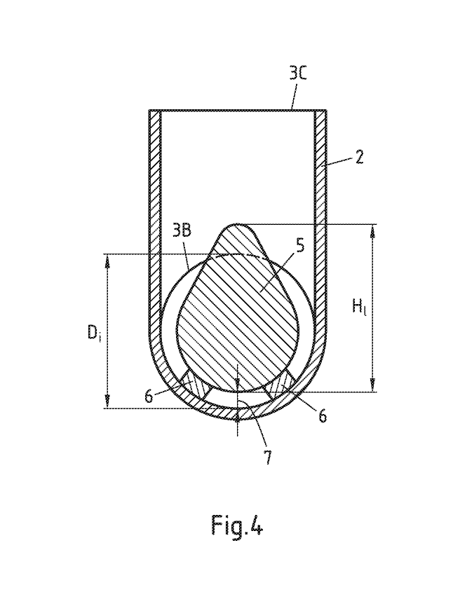

FIG. 4: the device from FIG. 2 in cross section along the section plane IV-IV, and

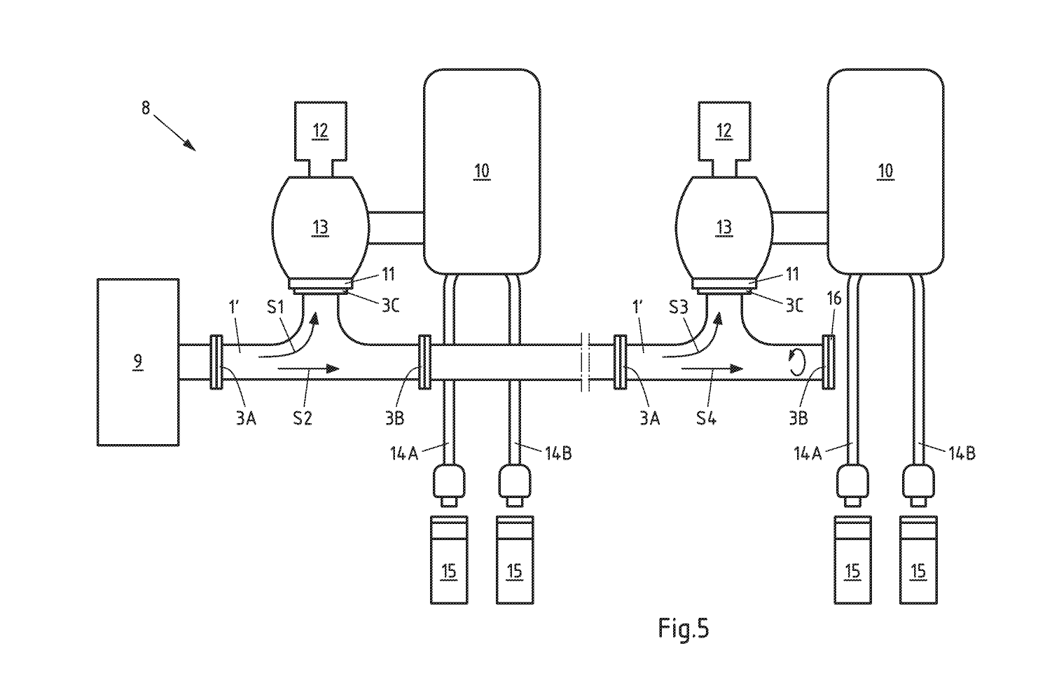

FIG. 5: a system according to the invention for filling foods with a device from FIG. 2.

FIG. 1 shows a device 1 known from the prior art for controlling the flow direction of fluids in a side view. The device 1 comprises a housing 2 with three connections 3A, 3B, 3C. The first connection 3A is arranged on a first axis A and the second connection 3B is arranged on a second axis B, wherein the axes A and B are mutually collinear. However, the first axis A and the second axis B extend partially outside the housing 2. The third connection 3C is arranged on a third axis C. The angle α between the third axis C and the first axis A, as well as the angle β between the first axis C and the second axis B is approximately 90°. Due to this design, such a device is sometimes referred to as a “T-piece”.

For example, the device 1 shown in FIG. 1 is used to direct fluids from a source (to be connected to the connection 3A) to two different destinations (to be connected to the connections 3B, 3C). For this purpose, the housing 2 has curved regions 4A, 4B, which change the flow direction of the fluid inflowing through the connection 3A in the direction of the second connection 3C. The change in flow direction is required to direct the inflowing fluid vertically upward against gravity. The fluid may be foods to be filled or, in the cleaning mode, a cleaning agent. However, the curved regions 4A, 4B conduct only a part of the fluid toward the connection 3C, while another part of the fluid is directed towards the connection 3B. The flow direction of the fluid is shown schematically by arrows. A disadvantage of this design is the fact that the two curved regions 4A, 4B constitute an obstacle, which results in that in the lower region of the housing 2 (in particular in the region in which run the first axis A and the second axis B outside of the housing 2) no straight connection between the two connections 3A and 3B exists. As a result, the device 1 cannot be used in a self-draining system in most of the positions, since the cleaning agent cannot drain off completely from the connection 3B to the connection 3A. Another disadvantage occurs when one of the connections is closed (e.g. when the device is used as an “end piece”). In the region of the closed connection (for example connection 3B), almost no flow then occurs, so that deposits of lumpy constituents of the fluid form in this area.

FIG. 2 shows a side view of a device 1′ according to the invention for controlling the flow direction of fluids. For those areas of the device 1′ which have already been described in connection with FIG. 1, corresponding reference numerals are used in FIG. 2. The device 1′ also comprises a housing 2 with three connections 3A, 3B, 3C. The first connection 3A is arranged on a first axis A and the second connection 3B is arranged on a second axis B, wherein the axes A and B are mutually collinear. The third connection 3C is arranged on a third axis C. The angle α between the third axis C and the first axis A has the same degree as the angle β between the first axis C and the second axis B of approximately 90°.

In contrast to the device 1 shown in FIG. 1, the device 1′ shown in FIG. 2 has a guide element 5. The guide element 5 serves to divide the flow inflowing into the housing 2 into two partial flows and at the same time to ensure a straight join between the two opposite connections. For this purpose, the guide element 5 has two curved surfaces 4A′, 4B′ and a straight surface 4C′. For example, a flow S inflowing through the first connection 3A can be divided by the guide element 5 into a first partial flow S1 and into a second partial flow S2, which are illustrated schematically by arrows in FIG. 2. The guide element 5 changes the flow direction of the first partial flow S1 in the direction of the third connection 3C, while the flow direction of the second partial flow S2 is not changed and continues to point in the direction of the second connection 3B. An advantage of dividing the flow S into two partial flows S1, S2 is that the fluid remains in motion in the area of a closed connection (e.g. connection 3B) due to the partial flow S2, so that deposits from particulate matter of the fluid are not a concern. The partial flow S2 thus also serves, inter alia, to continuously purge the area in front of a closed connection. The housing 2 and the guide element 5 are thus designed such that the first partial flow S1 is conducted in the direction of the connection 3C and that the second partial flow S2 is conducted in the direction of another connection than the first partial flow S1, namely in the direction of the connection 3B. A further advantage is that the area provided for the second partial flow S2 ensures that in the lower area of the housing 2 there is a straight join between the two connections 3A, 3B, which ensures that the device 1′ does not constitute an obstacle and can be used in a self-draining system. This is advantageous, for example, after cleaning in order to allow run-off detergent to run through the device 1′.

In the device 1′ shown in FIG. 2, the guide element 5 is connected via two bridges 6 to the housing 2 (the rear of the two bridges is hidden in FIG. 2 by the guide element 5). The bridges 6 have for example a length in the range between 3 mm and 5 mm, so that a corresponding distance 7 between the guide element 5 and the housing 2 is maintained. On the one hand, the size of the gap 7 determines the size of the partial flow S2 and, on the other hand, has an influence on the maximum size of the particles which can pass through the guide element 5 with the partial flow S2. In the device 1′ shown in FIG. 2, the ratio of the partial flow S1 to the partial flow S2 is approximately 4:1. Both the housing 2 and the guide element 5 are preferably made of stainless steel. The connections 3A, 3B, 3C of the housing 2 have, for example, a nominal diameter in the range between DN 25 (for pipe threads 1 inch) and DN 125 (for pipe threads 5 inches). The guide element 5 has a height Hi in the vertical direction and the housing 2 has an inner diameter Di (in particular in the region of the connections 3A, 3B, 3C). The height Hi of the guide element 5 is greater than the inner diameter Di of the housing 2, wherein a reliable change of the flow direction in the direction of the third outlet 3C is achieved, in particular for products with low viscosity or with a low proportion of particulates.

FIG. 3 shows the device 1′ of FIG. 2 in a longitudinal cross section. Here, too, corresponding reference numerals are used for those areas of the device 1′ which have already been described in connection with FIG. 1 or FIG. 2. In a longitudinal cross section, the guide element 5 and the regions inside the hollow housing 2 provided for the partial flows S1, S2 are particularly clearly visible.

In FIG. 4, the device of FIG. 2 is shown in cross section along the section plane IV-IV. Here, too, corresponding reference numerals are used for those areas of the device 1′ which have already been described in connection with FIG. 1 to FIG. 3. In cross section, the position of the two bridges 6 of the guide element 5 is particularly clearly visible. Under the two bridges 6—i.e. “within” the two bridges 6—a channel is formed for the partial flow S2 and over the two bridges 6—i.e. “outside” of the two bridges 6—a channel is formed for the partial flow S1.

FIG. 5 shows a system 8 according to the invention for filling foods with two devices 1′ from FIG. 2. The system 8 initially comprises two of the previously described devices 1′, which are designed identically. In addition, the system 8 comprises a container 9 for food to be filled, which is connected to the first connection 3A of the first device 1′ (shown in FIG. 5 left). Furthermore, the system 8 comprises two product tanks 10, which are each connected to the third connection 3C of the two devices 1′. In this way, the food from the two devices 1′ can enter the product tanks 10. The system 8 also has two valves 11, which are also called “product inlet valves” and are each arranged between the connection 3C of the device 1′ and the product tank 10 assigned thereto. The valves 11 are controlled by drives 12, which are connected to valve housings 13 of the valves 11. Finally, the system 8 comprises outlets 14A, 14B connected to the product tank 10 for filling the food in packaging 15.

The operation of the system 8 shown in FIG. 5 is described below: The foods to be filled are provided in the container 9. From the container 9, the foods are introduced into the first device 1′ (shown on the left in FIG. 5). There, the flow is divided in the manner already described above into two partial flows S1, S2, of which the first partial flow S1 is directed vertically upward in the direction of the connection 3C and of which the second partial flow S2 is redirected approximately horizontal to the second device 1′ (shown in FIG. 5 right). In the second device 1′, the flow is also divided in the manner already described above into two partial flows S3, S4, of which the first partial flow S3 is directed vertically upward in the direction of the connection 3C. However, the second partial flow S4 is not redirected to a further device 1′; instead, it flows to the outlet 3C of the second device 1′, which is shut off by a closure 16. Instead of the closure 16, a return could also be provided to form a circuit (not shown in FIG. 5). The food leaves the two devices 1′ vertically through the upper outlets 3C and flows through the valves 11 arranged there (as well as through the valve housings 13) into the product tanks 10. The product tanks 10 serve as reservoirs from which the food is filled into packaging 15 through outlets 14A, 14B connected to the product tanks 10.

In the first device 1′ (shown in FIG. 5 left), the division of the flow into two partial flows S1, S2 serves the purpose of directing the first partial flow S1 vertically upwards to the first product tank 10 and to supply the second device 1′ (shown in FIG. 5 right) (and possibly other devices) with the second partial flow S2. In the second device 1′, however, the division of the flow into two partial flows S3, S4 serves a different purpose: although the first partial flow S3 is in turn directed vertically upwards to a product tank 10, however, the second partial flow S4 supplies no further devices, but serves to flush the area in front of the connection 3C closed off by the closure 16, to prevent the formation of deposits there.

From the construction of system 8 shown in FIG. 5, a further advantage, already mentioned above, becomes clear: due to the design of the guide elements 5, the system 8 is self-draining. For example, after the cleaning of the system 8, cleaning agent can completely flow out of the right-hand part of the system 8 through the second (right-hand) device 1′ and then through the first (left-hand) device 1′ and the system 8 can be evacuated in the region of container 9 (then to be removed). This is possible since the guide elements 5 in the devices 1′ are designed in such a way that—unlike the device 1 shown in FIG. 1—there is a straight connection between the two opposite connections 3A, 3B.

### LIST OF REFERENCE SIGNS

1, 1′: Device

2: Housing

3A, 3B, 3C: Connection

4A, 4B: Curved region

4A′, 4B′: Curved surface

4C′: Straight surface

5: Guide element

6: Bridge

7: Distance

8: System

9: Container

10: Product tank

11: Valve

12: Drive

13: Valve housing

14A, 14B: Outlet

15: Packaging

16: Closure

A, B, C: Axis

S: Flow

S1, S2, S3, S4: Partial flow

α, β: Angles

Hₗ: Height (of the guide element 5)

Dᵢ: Inner diameter (of the housing 2)

1. A device for controlling the flow direction of fluids, comprising:
a housing having at least three connections, and
a guide element for dividing the low inflowing into the housing into at least two partial flows,
wherein the connections are inlets and/or outlets for the fluids,
wherein the first connection is arranged on a first axis,
wherein the second connection is arranged on a second axis, and
wherein the third connection is arranged on a third axis, which runs at an angle to the first axis and the second axis, wherein the guide element is connected via at least one bridge to the housing and the bridge has a length of at least 3 mm so that a corresponding minimum distance between the guide element and the housing is maintained.

2. The device according to claim 1, characterised in that the housing and the guide element are designed such that a first partial flow is guided in the direction of one connection and that a second partial flow is guided in the direction of another connection than the first partial flow.

3. The device according to claim 1, wherein the first axis and the second axis run parallel, in particular collinear, to one another.

4. The device according to claim 1, wherein underside of the housing opposite the third connection is designed to be straight between the first connection and the second connection.

5. The device according to claim 1, wherein the third axis is inclined at an angle of at least 45° with respect to the first axis and/or with respect to the second axis.

6. The device according to claim 1, wherein the angle between the third axis and the first axis and/or the second axis is between 80° and 100°.

7. The device according to claim 1, wherein the guide element is formed integrally with the housing.

8. The device according to claim 1, wherein the guide element is designed as an insert which is connected to the housing.

9. (canceled)

10. (canceled)

11. The device according to claim 1, wherein the guide element divides the two partial flows in a ratio of at least 3:1.

12. The device according to claim 1, wherein the housing and/or the guide element are made of stainless steel.

13. The device according to claim 1 for filling food products.

14. A system for filling food products, comprising:
at least one device for controlling the flow direction of fluids, comprising:
a housing having at least three connections, and
a guide element for dividing the flow inflowing into the housing into at least two partial flows,
wherein the connections are inlets and/or outlets for the fluids,
wherein the first connection is arranged on a first axis,
wherein the second connection is arranged on a second axis, and
wherein the third connection is arranged on a third axis, which runs at an angle to the first axis and the second axis, wherein the guide element is connected via at least one bridge to the housing and the bridge has a length of at least 3 mm so that a corresponding minimum distance between the guide element and the housing is maintained,
at least one container for food products to be filled, wherein the container is connectable with the first connection of the device,
at least one product tank connected to the third connection of the device,
at least one valve arranged between the third connection of the device and the product tank, and
a plurality of outlets connected to the product tank for filling packages with the food products.

15. The system according to claim 14, wherein the third connection of the device is located above the first connection and the second connection.

16. The device according to claim 1, wherein the bridge has a length of at least 5 mm.

17. The device according to claim 1, wherein the guide element is connected via two bridges.

18. The device according to claim 1, wherein the third axis is inclined at an angle of at least 60° with respect to the first axis and/or with respect to the second axis.

19. The device according to claim 1, wherein the guide element divides the two partial flows in a ratio of at least 4:1.
